(19) United States
(12) Patent Application Publication
(10) Pub. No.: US 2017/0182501 A1
(43) Pub. Date: Jun. 29, 2017

(54) CENTRIFUGAL SEPARATION APPARATUS

(71) Applicants: JIANGSU HUADONG INSTITUTE OF LI-ION BATTERY CO., LTD., Suzhou (CN); TSINGHUA UNIVERSITY, Beijing (CN)

(72) Inventors: Xiang-Ming He, Beijing (CN); Jing Luo, Suzhou (CN); Li Wang, Beijing (CN); Jian-Li Zhang, Suzhou (CN); Shao-Jun Liu, SR., Suzhou (CN); Jian-Jun Li, Beijing (CN); Yu-Ming Shang, Beijing (CN); Yu-Mei Ren, Suzhou (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/456,167

(22) Filed: Mar. 10, 2017

Related U.S. Application Data
(63) Continuation of application No. PCT/CN2015/082144, filed on Jun. 24, 2015.

(30) Foreign Application Priority Data
Sep. 15, 2014 (CN) 201410467262.9

(51) Int. Cl. B04B 11/02; B04B 7/12; B04B 1/06

(52) U.S. Cl. CPC B04B 11/02; B04B 1/06; B04B 7/12

(57) ABSTRACT

A centrifugal separation apparatus is disclosed. The centrifugal separation apparatus comprises a rotary drum, wherein an inlet opening and an outlet opening are respectively defined on opposite ends of the rotary drum along a central axis of the rotary drum. A fixing rod is disposed on the central axis, a baffle plate is disposed on the fixing rod, and a distance from each point on an edge of the baffle plate to the central axis is greater than a radius of the outlet opening.

### CROSS-REFERENCE TO RELATED APPLICATIONS

This application claims all benefits accruing under 35 U.S.C. §119 from China Patent Application No. 201410467262.9, filed on Sep. 15, 2014 in the State Intellectual Property Office of China, the content of which is hereby incorporated by reference. This application is a continuation under 35 U.S.C. §120 of international patent application PCT/CN2015/082144 filed on Jun. 24, 2015, the content of which is also hereby incorporated by reference.

### FIELD

The present disclosure relates to centrifugal separation apparatuses, especially to centrifugal separation apparatuses for treating suspension liquids containing nanosized solid particles.

### BACKGROUND

A tubular centrifuge having a high rotation speed is often used to treat a suspension liquid, especially liquid consisting of a solvent with high viscosity and small solid particles, which are difficult to separate. FIG. 1 is a schematic view of a rotary drum 100 of a common tubular centrifuge. Referring to FIG. 1, an inlet opening 110 and an outlet opening 120 are respectively defined on two ends of the rotary drum 100 along a central axis thereof. When the rotary drum 100 is rotated at a high speed, material introduced into the rotary drum 100 from the inlet opening 110 rotates with the rotary drum 100, and spirally ascends along the central axis in a flow path direction 30, during which solid particles 40 in the material with a higher specific gravity gradually deposit on an inner wall of the rotary drum 100 to form a sediment layer 50, while the residual liquid with a lower specific gravity continues to spirally ascend and discharge out from the outlet opening 120.

The smaller the solid particles, the more difficult the solid particles separate from the suspension liquid. A separation factor (e.g. ratio of centrifugal to gravitational forces) and a residence time (e.g. average time element of fluid remains in the centrifuge) of the material in the rotary drum 100 are factors which can affect the separation effect. The higher the separation factor, the greater the impetus of the centrifugal separation, and the better the separation effect. The theoretical separation factor (F) of the tubular centrifuge can be calculated by F=1.12×10⁻³RN², wherein R is an inner radius of the rotary drum 100, and N is a rotation speed of the rotary drum 100. However, due to an air resistance and an inertia force of the material, the material rotates around the central axis at a certain distance away from the inner wall of the rotary drum 100. Therefore, an effective separation factor (f) of the material is much less than the theoretical separation factor (F) of the tubular centrifuge. The effective separation factor (f) of the material can be calculated by f=1.12×10⁻³m², wherein r is an effect radius for the material, which is a distance from the material to the central axis of the rotary drum 100, and n is a rotation speed of the material. In addition, the longer the length of the rotary drum 100, the longer the material resides therein, and the better the separation effect will be. However, the length of the rotary drum 100 is limited by the material of the rotary drum 100 and a cost consideration. As a result, the separation effect of the tubular centrifuge to the suspension liquid is unsatisfactory.

### BRIEF DESCRIPTION OF THE DRAWINGS

Implementations are described by way of example only with reference to the attached figures.

FIG. 1 is a schematic view of a rotary drum of a common centrifugal separation apparatus.

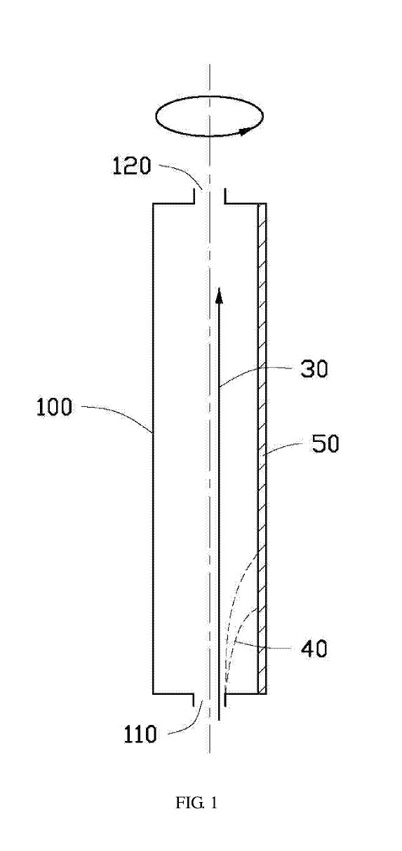

FIG. 2 is a schematic view of one embodiment of a centrifugal separation apparatus.

FIG. 3 is a cross-section view of FIG. 2.

FIG. 4 is a perspective view of one embodiment of a fixing rod and a plurality of baffle plates.

### DETAILED DESCRIPTION

A detailed description with the above drawings is made to further illustrate the present disclosure.

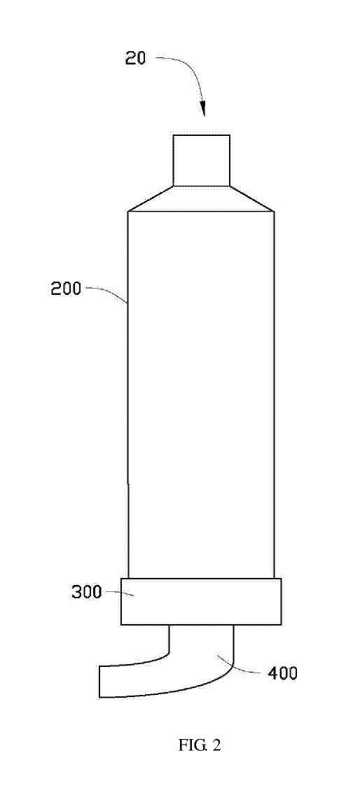

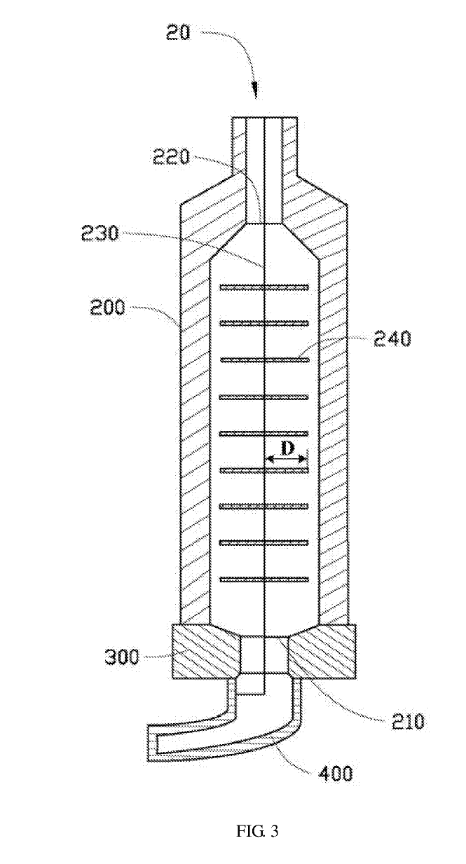

Referring to FIG. 2 and FIG. 3, one embodiment of a centrifugal separation apparatus 20 comprising a rotary drum 200 is disclosed. An inlet opening 210 and an outlet opening 220 can be respectively defined on two ends of the rotary drum 200 along a central axis thereof. A fixing rod 230 can be disposed on the central axis of the rotary drum 200. At least one baffle plate 240 can be disposed on the fixing rod 230. A distance D from each point on an edge of the baffle plate 240 to the central axis can be greater than a radius of the outlet opening 220.

The rotary drum 200 can be a cylinder defining a chamber therein. The inlet opening 210 and the outlet opening 220 can be respectively defined on two ends of the chamber, and communicate with the chamber. When the rotary drum 200 is rotated, a material can be input into the rotary drum 200 from the inlet opening 210, and rotated with the rotary drum 200 at high speed.

The radius of the outlet opening 220 can be an effective radius which is calculated according to an effective residence volume of the rotary drum 200. That is, the radius of the outlet opening 220 can be equivalent to an effective radius of the material in the rotary drum 100 without the baffle plate 240. When rotated at high speed, the material can spirally ascend (e.g. from the inlet opening 210 to the outlet opening 220) along the central axis by centrifugal force. As the distance D from each point on the edge of the baffle plate 240 to the central axis is greater than the radius of the outlet opening 220, in the process of spirally ascending, the material can encounter the baffle plate 240, and flow over the baffle plate 240 to the edge thereof. When the material reaches the edge of the baffle plate 240, the material can continue to spirally ascend until it encounters another baffle plate 240. This process can be repeated in the rotary drum 200 among at least some of the baffle plates 240. A flow of the material in the rotary drum 200 can be deflected by the baffle plate 240. Due to the deflection, a flow path of the material is extended, thereby lengthening the residence time, enlarging the effective radius, increasing the effective separation factor, and improving the separating efficiency of the material in the rotary drum 200.

A structure and a shape of the baffle plate 240 are not limited, as long as the distance D from each point on the edge of the baffle plate 240 to the central axis is greater than the radius of the outlet opening 220. In one embodiment, a plurality of baffle plates 240 can be disposed on the fixing rod 230 spaced from each other. The plurality of baffle plates 240 can all be planar structures. More baffle plates 240 can be disposed in the rotary drum 200 due to the planar structures, thereby improving the deflection effect. The plurality of baffle plates 240 having the planar structures can be substantially perpendicular to the fixing rod 230. A center of gravity of the baffle plate 240 can be located on the central axis to ensure a dynamic equilibrium of the fixing rod 230.

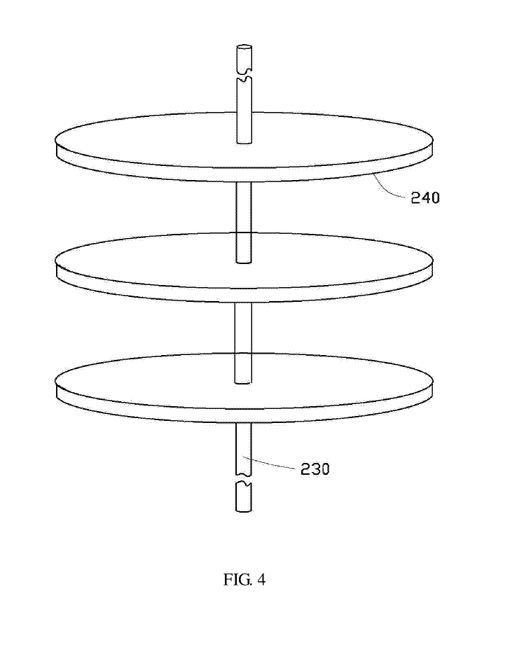

Referring to FIG. 4, the baffle plate 240 can be a circular plate having a center located on the central axis. The material not only flows along a radial direction over the baffle plate 240, but also along a tangential direction of the baffle plate 240, and thus tends to flow to points along the edge of the baffle plate closer to the central axis. All points of the edge of the circular baffle plate 240 are at the same distance D from the central axis, which maximizes the deflection effect of the baffle plate 240.

The larger the distance D from the edge of the baffle plate 240 to the central axis, the longer the flow path of the material in the rotary drum 200. In one embodiment, the distance D from each point of the edge of the baffle plate 240 to the central axis can be in a range from about ½ to about ⅘ of an inner radius of the rotary drum 200, so that not only better deflection effect can be obtained, but the rotary drum 200 and the baffle plate 240 would not hit each other during vibration of the rotary drum 200 in an accelerating process or decelerating process.

In addition, a size and number of the baffle plates 240, and a spacing distance between two adjacent baffle plates 240 can be designed to optimize the effective radius and the residence time according to different materials comprising different solid particles and solvents. In one embodiment, the spacing distance between any two adjacent baffle plates 240 can be in a range from about half to about twice of the inner radius of the rotary drum 200, which is more conducive to obtain optimal deflection effect.

The one or more baffle plates 240 can be fixed on the fixing rod 230. In one embodiment, the fixing rod 230 can be a solid structure to fix the baffle plates 240 together as a group. The fixing rod 230 can be configured to rotate about the rotary drum 200, or remain still relative to the rotation of the rotary drum 200. In one embodiment, the fixing rod 230 can be fixed on the centrifugal separation apparatus 20, and can be stationary relatively to the rotary drum 200.

A rotation speed of the rotary drum 200 can be equal to or greater than, for example, 10000 revolutions per minute (r/min), to separate nanosized solid particles from a solvent with a high viscosity in a suspension liquid. The rotational velocity of the rotary drum 200 can be adjusted to a threshold speed such that the particles separate from the solvent in the material.

In one embodiment, the centrifugal separation apparatus 20 can be a tubular centrifuge. The centrifugal separation apparatus 20 can comprise a bearing seat 300 and a liquid inlet device 400. One end of the rotary drum 200 where the inlet opening 210 is defined can be installed in the bearing seat 300. The liquid inlet device 400 can be connected with the bearing seat 300, and communicate with the inlet opening 210. The liquid inlet device 400 can be configured to fix the fixing rod 230. The fixing rod 230 can be directly fixed on the liquid inlet device 400.

The centrifugal separation apparatus 20 can further comprise a frame and a motor fixed on the frame (not shown). The lower end of the rotary drum 200 defining the inlet opening 210 can be connected with a support member (not shown) fixed on the frame. The upper end of the rotary drum 200 defining the outlet opening 220 can be connected with a rotating shaft (not shown) connected to the motor. A liquid accumulation disc (not shown) can be disposed upon the upper end of the rotary drum 200, and communicate with the outlet opening 220 via a discharge pipe (not shown). The rotating shaft can penetrate through the liquid accumulation disc to connect with the upper end of the rotary drum 200 via a bearing (not shown). The rotary drum 200 can be rotated by the motor via the rotating shaft. The suspension liquid can be input into the rotary drum 200 from the inlet opening 210, spirally ascend along the central axis by centrifugal force, and be deflected by the baffle plates 240, during which the nanosized solid particles in the suspension liquid gradually deposit on the inner wall of the rotary drum 200 to form a sediment layer, while the residual liquid continues to spirally ascend, discharge out from the outlet opening 120, and be collected by the liquid accumulation disc.

### EXAMPLE

A fixing rod is disposed on a central axis of a rotary drum of a tubular centrifuge, and fixed on a liquid inlet device thereof. Five uniformly spaced circular baffle plates, which are parallel to each other, and perpendicular to the central axis, are disposed on the fixing rod. Centers of the five circular baffle plates are all located on the central axis. Distances between any two adjacent circular baffle plates are equal to an inner radius of the rotary drum. Radiuses of the five circular baffle plates are both equal to ¾ of the inner radius of the rotary drum. When the rotary drum of the tubular centrifuge is rotated at a rotation speed of 16000 r/min, an effective separation factor of a material in the rotary drum reaches to 21000, and a residence time thereof is twice as much as in a rotary drum without the baffle plates under the same separation condition.

In the present disclosure, by disposing one or more of the baffle plates in the rotary drum of the centrifugal separation apparatus, the flow path of the material introduced into the rotary drum is prolonged, the effective separation factor thereof is increased, and the residence time thereof is lengthened, so that nanosized particles can be separated from the solvent having a high viscosity using the centrifugal separation apparatus. In addition, the size and number of the baffle plates, and the spacing distance between two adjacent baffle plates can also be designed to optimize the effective separation factor and the residence time according to different materials to be separated, the material comprising different solid particles and solvents.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A centrifugal separation apparatus, comprising:
a rotary drum having an inlet opening and an outlet opening defined at ends of the rotary drum along a central axis of the rotary drum;
a fixing rod disposed along the central axis; and
at least one baffle plate disposed on the fixing rod, wherein a distance from each point on an edge of the at least one baffle plate to the central axis is greater than a radius of the outlet opening.

2. The centrifugal separation apparatus of claim 1, wherein the rotary drum is cylindrical and defines a chamber therein, and the inlet opening and the outlet opening are respectively defined at two ends of the chamber, and communicate with the chamber.

3. The centrifugal separation apparatus of claim 1, wherein the at least one baffle plate comprises a plurality of baffle plates disposed on the fixing rod and spaced from each other.

4. The centrifugal separation apparatus of claim 3, wherein the plurality of baffle plates are planar structures.

5. The centrifugal separation apparatus of claim 4, wherein the plurality of baffle plates are perpendicular to the central axis.

6. The centrifugal separation apparatus of claim 4, wherein the plurality of baffle plates are circular plates having centers located on the central axis.

7. The centrifugal separation apparatus of claim 3, wherein a spacing distance between any two adjacent baffle plates is in a range from about half to about twice of an inner radius of the rotary drum.

8. The centrifugal separation apparatus of claim 1, wherein the distance is in a range from about ½ to about ⅘ of an inner radius of the rotary drum.

9. The centrifugal separation apparatus of claim 1, wherein a center of gravity of the baffle plate is located on the central axis.

10. The centrifugal separation apparatus of claim 1, wherein the fixing rod is a solid structure.

11. The centrifugal separation apparatus of claim 1, wherein the fixing rod is configured to rotate with the rotary drum.

12. The centrifugal separation apparatus of claim 1, wherein the fixing rod is fixed relative to rotation of the rotary drum.

13. The centrifugal separation apparatus of claim 1, further comprising a bearing seat and a liquid inlet device, wherein one end of the rotary drum where the inlet opening is defined is installed in the bearing seat, the liquid inlet device is connected with the bearing seat, and communicates with the inlet opening, and the fixing rod is fixed on the liquid inlet device.

14. The centrifugal separation apparatus of claim 1, wherein a rotation speed of the rotary drum is equal to or greater than 10000 revolutions per minute.

15. The centrifugal separation apparatus of claim 1, being a tubular centrifuge.
